(19) United States
(12) Patent Application Publication
(10) Pub. No.: US 2022/0267123 A1
(43) Pub. Date: Aug. 25, 2022

(54) CABLE SAFETY DEVICE

(71) Applicant: James Henry Bigham, Kamloops (CA)

(72) Inventor: James Henry Bigham, Kamloops (CA)

(21) Appl. No.: 17/182,187

(22) Filed: Feb. 22, 2021

(51) Int. Cl. B66D 1/54

(52) U.S. Cl. CPC B66D 1/54

(57) ABSTRACT

A cable safety device that is configured to be operably coupled to a portion of a cable so as to dampen and reduce a whiplash movement of the cable in the event the cable ruptures. The present invention includes a body wherein the body is planar and annular in shape. The body includes an outer perimeter edge. A center aperture is formed in the body and is configured to releasably secure to a portion of a cable. A notch is formed in the body wherein the notch is wider proximate the outer perimeter edge narrowing in shape progressively towards the center aperture. A pair of orifices are formed through the body and are opposedly located with respect to the center aperture. Structural members are journaled through the pair of orifices. In a preferred deployment of the present invention a multitude of body elements are placed adjacent each other.

### FIELD OF THE INVENTION

The present invention relates generally to safety equipment, more specifically but not by way of limitation, a device configured to be operably coupled to a cable wherein the cable has a high tension force thereon wherein the device of the present invention is configured to surroundably mount a portion of the cable so as to prevent backlash in the event of failure or decoupling of the cable.

### BACKGROUND

Cables such as but not limited to steel cables are utilized in a multitude of application. By way of example but not limitation cables are often coupled to winches and/or motors and are subjected to high weight loads. Applications can include but are not limited to boat lifts, construction equipment and winch assemblies wherein the winch/cable assembly can be deployed move equipment and other similar tasks. Regardless of the application, when a winch/cable assembly is deployed there is always a very high tension force. While cables are designed to accommodate various loads, inevitably cables are subjected to conditions that can cause the failure thereof.

In the event of a cable failure on a winch/cable assembly an extremely hazardous condition for workers that are proximate and/or utilizing the equipment. When a cable fails, due to the high tension a backlash will occur and the cable will uncontrollably travel in various directions. A catastrophic cable failure can send portions of the cable in a whiplash motion with enough force that can potentially sever a limb or cause other significant injuries.

Accordingly, there is a need for a safety device that can be releasably secured to a cable so as to prevent a backlash motion in order to inhibit injury to individuals proximate thereto.

### SUMMARY OF THE INVENTION

It is the object of the present invention to provide a cable safety device that is configured to be surroundably mounted to a cable wherein the present invention includes a body having a first end and a second end.

Another object of the present invention is to provide a safety apparatus operable to inhibit a backlash motion on a cable in the event of a cable failure wherein the body of the present invention is manufactured from an impact absorption material.

A further object of the present invention is to provide a cable safety device that is configured to be surroundably mounted to a cable wherein the body of the present invention is a modified disc shape having an opening providing access to a center aperture.

Still another object of the present invention is to provide a safety apparatus operable to inhibit a backlash motion on a cable in the event of a cable failure wherein the body includes structural members opposedly located with respect to the center aperture.

An additional object of the present invention is to provide a cable safety device that is configured to be surroundably mounted to a cable wherein the structural members of the present invention extend the length of the body intermediate the first end and second end.

Yet a further object of the present invention is to provide a safety apparatus operable to inhibit a backlash motion on a cable in the event of a cable failure wherein the present invention is deployed so as to utilize a multitude of the disc shaped bodies in an adjacent configuration in order provide a length of at least several feet.

Another object of the present invention is to provide a cable safety device that is configured to be surroundably mounted to a cable wherein the structural members are journaled through an aperture formed in the body.

Still a further object of the present invention is to provide a safety apparatus operable to inhibit a backlash motion on a cable in the event of a cable failure wherein the body can be manufactured from a material such as but not limited to recycle rubber tires.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an assembled embodiment of the present invention; and

FIG. 2 is a perspective view of a single disc body of the present invention engaged with an exemplary cable.

### DETAILED DESCRIPTION

Referring now to the drawings submitted herewith, wherein various elements depicted therein are not necessarily drawn to scale and wherein through the views and figures like elements are referenced with identical reference numerals, there is illustrated a cable safety device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the cable safety device 100 includes a body 10 that is planar in manner and annular in form. The body 10 is manufactured from a material such as but not limited to rubber. It should be understood within the scope of the present invention that the body 10 could be manufactured from a variety of impact absorbing and movement reducing material. Furthermore, it should be understood within the scope of the present invention that the body 10 could be manufactured in alternate sizes so as to accommodate alternate diameters of cables. Additionally, it should be understood within the scope of the present invention that the body 10 could be manufactured in alternate thicknesses.

The body 10 is disc shaped having an outer perimeter edge 11 and a first side 8 and second side 9. The body 10 has formed therein a center aperture 15. The center aperture 15 is formed utilizing suitable techniques. The center aperture 15 is configured so as to be releasably secured to a cable 99. It should be understood within the scope of the present invention that the center aperture 15 could be provided in alternate diameters so as to facilitate the releasable securing of the body 10 to alternate sizes of cables. The center aperture 15 is accessed utilizing notch 20 formed in the body 10. The notch 20 is formed so as to have angular entry sidewalls 16,17 wherein the sidewalls 16, 17 extend from the outer perimeter edge 11 to the center aperture 15. The sidewalls 16, 17 form a notch 20 wherein the notch 20 has a width that is wider proximate the outer perimeter edge 11. This shape facilitates an improved operable coupling with the cable safety device 100 and the cable 99 when releasably securing the cable safety device 100 to the cable 99. While the notch 20 is illustrated and discussed herein in a preferred form, it should be understood within the scope of the present invention that the notch 20 could be formed in alternate shapes and achieve the desired objective discussed herein.

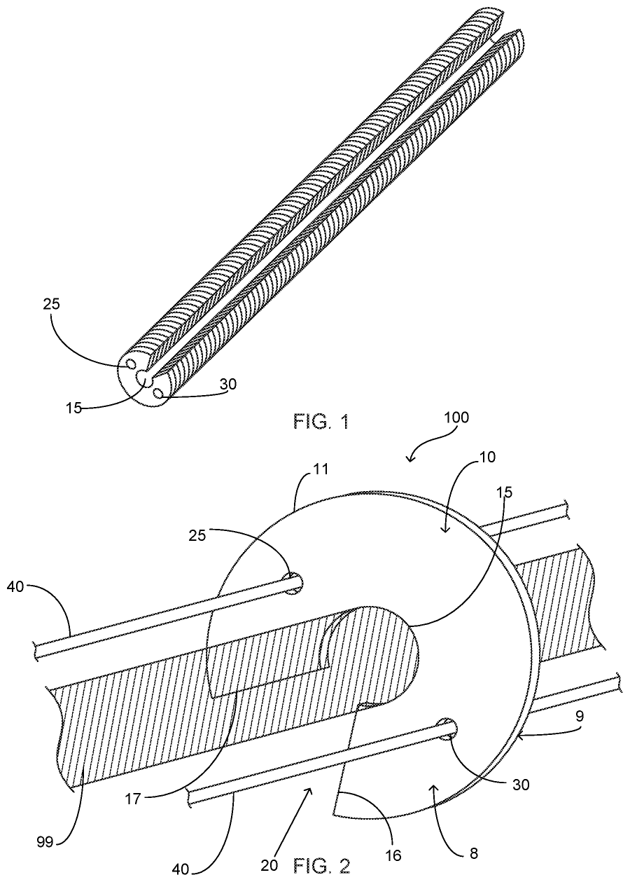

Located on opposing sides of the center aperture 15 are first orifice 25 and second orifice 30. The first orifice 25 and second orifice 30 are formed utilizing suitable techniques and are sized so as to accommodate the structural members 40 therethrough. The structural members 40 are journaled through the first orifice 25 and second orifice 40 wherein the structural members 40 will extend the length of the final assembly of the cable safety device 100. As is illustrated herein in FIG. 1, the final assembly of the cable safety device 100 comprises of a plurality of body 10 elements placed adjacent each other to form a desired length. The structural members 40 are present to further increase the reduction of whiplash or other similar type motion in the event the cable 99 has a catastrophic failure. It is contemplated within the scope of the present invention that the structural members 40 could be manufactured from radial enforced rubber or some alternate suitable material. While the embodiment of the cable safety device 100 illustrated and discussed herein has a first orifice 25 and a second orifice 30 opposedly located with respect to the center aperture 15, it is contemplated within the scope of the present invention that the body 10 could have as few as one orifice or more than two that are configured to receive a structural member 40 therethrough.

While the preferred embodiment includes an assembly of a multitude of the the cable safety device 100 as illustrated herein in FIG. 1, it is contemplated within the scope of the present invention that the cable safety device 100 could be manufactured as illustrated in FIG. 1 wherein the assembly of FIG. 1 is a contiguous piece of material manufactured as the body 10 has been described herein in order to produce the desired shape and a particular length. It should be understood within the scope of the present invention that the cable safety device 100 could be assembled and/or manufactured in a variety of alternate lengths as needed for a particular application. The cable safety device 100 is assembled from a multitude of adjacent body 10 elements in order to provide movement reduction as desired within the scope of the present invention. Assembling a multitude of adjacent body 10 elements that are independently movable provides a structure that is advantageous for reduction of whiplash type movements of cables.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A cable safety device that is configured to reduce movement of a cable ensuing failure of the cable wherein the cable safety device comprises:
a body, said body being planar in manner, said body having a center aperture, said body having a shape being defined by an outer perimeter edge;
a notch, said notch being formed in said body, said notch extending from said outer perimeter edge to said center aperture; and
wherein said body is configured to be surroundably mounted to a portion of the cable.

2. The cable safety device as recited in claim 1, and further including at least one orifice, said at least one orifice being formed through said body, said at least one orifice being adjacent said center aperture.

3. The cable safety device as recited in claim 2, and further including at least one structural member, said at least one structural member being journaled through said at least one orifice.

4. The cable safety device as recited in claim 3, wherein an embodiment of the cable safety device includes a multitude of said body placed adjacent each other.

5. The cable safety device as recited in claim 4, wherein the at least one structural member extends a full length of the embodiment.

6. The cable safety device as recited in claim 5, wherein said notch is formed so as to have a width proximate said outer perimeter edge that is greater than a width proximate said center aperture.

7. The cable safety device as recited in claim 6, wherein said body is manufactured from rubber.

8. A cable safety device that is configured to surroundably mount a portion of a cable so as to inhibit uncontrolled movement thereof in an event of a rupture of the cable wherein the cable safety device comprises:
a body, said body being planar in manner and annular in shape, said body having a first side and a second side, said body having a center aperture;
a notch, said notch being formed in said body, said notch extending from said outer perimeter edge to said center aperture, said notch being defined by opposing sidewalls, said notch having a width proximate said outer perimeter edge that is greater than a width of said notch proximate said center aperture;
a first orifice and a second orifice, said first orifice and said second orifice being journaled through said body, said first orifice and said second orifice being opposedly located with respect to said center aperture.

9. The cable safety device as recited in claim 8, and further including a first structural member and a second structural member, said first structural member being journaled through said first orifice, said second structural member being journaled through said second orifice.

10. The cable safety device as recited in claim 9, wherein the cable safety device is deployed so as to place a plurality of said body adjacent to each other along a portion of a cable.

11. The cable safety device as recited in claim 10, wherein the body is manufactured from rubber.

12. The cable safety device as recited in claim 11, wherein said first structural member and said second structural member operable to diminish a whiplash like movement in conjunction with said body.
